(19) United States
(12) Patent Application Publication
(10) Pub. No.: US 2025/0226780 A1
(43) Pub. Date: Jul. 10, 2025

(54) SENSORLESS CONTROL OF A BLDC MOTOR DRIVE FOR A STAND MIXER

(71) Applicant: Haier US Appliance Solutions, Inc., Wilmington, DE (US)

(72) Inventors: Joseph Wilson Latham, Louisville, KY (US); Meher Prasadu Kollipara, Louisville, KY (US)

(21) Appl. No.: 18/404,486

(22) Filed: Jan. 4, 2024

(51) Int. Cl. H02P 23/14; A47J 43/044; A47J 43/08; H02P 25/03; H02P 27/08

(52) U.S. Cl. CPC H02P 23/14; A47J 43/044; A47J 43/082; H02P 25/03; H02P 27/08; A47J 2043/04472

(57) ABSTRACT

A stand mixer appliance is provided. The stand mixer includes a base, a housing pivotally mounted to the base, a mixer shaft rotatably mounted on the housing, and a motor assembly. The motor assembly includes a motor having at least a rotor and a stator and is operably coupled to the mixer shaft such that the mixer shaft is rotatable by the motor, a motor drive, a sensorless feedback system having one or more feedback circuits coupled to the motor drive, and a controller operably coupled to the sensorless feedback system. The sensorless feedback system is configured to obtain feedback measurements of one or more electrical characteristics of the stator. The controller is configured to implement a six-step commutation control scheme and is further configured to operate the motor drive based at least in part on the feedback measurements obtained by the sensorless feedback system.

### FIELD

Example aspects of the present disclosure relate to synchronous-type motor drives in appliances, such as stand mixers.

### BACKGROUND

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. Critical to the function and operation of the stand mixer, a robust motor drive is needed that is capable of both low speed, high torque operation and high speed, low torque operation. In current practice, brushed direct current (DC) motors are used to drive the stand mixer. Over time, however, the “brushes” in a brushed DC motor break down, which can result in decreased motor life and increased maintenance costs.

### SUMMARY

Aspects and advantages of embodiments of the present disclosure will be set forth in part in the following description, or can be learned from the description, or can be learned through practice of the embodiments.

One example aspect of the present disclosure is directed to a motor assembly for a stand mixer appliance. The motor assembly may include a motor having at least a rotor and a stator. The motor assembly may further include a motor drive and a sensorless feedback system having one or more feedback circuits coupled to the motor drive. The sensorless feedback system may be configured to obtain feedback measurements of one or more electrical characteristics of the stator. The motor assembly may further include a controller operably coupled to the sensorless feedback system. The controller may be configured to operate the motor drive based at least in part on the feedback measurements obtained by the sensorless feedback system.

Another example aspect of the present disclosure is directed to a method for operating a stand mixer appliance. The method may include obtaining, via a sensorless feedback system of the stand mixer of the stand mixer appliance, feedback measurements of one or more electrical characteristics of a motor of the stand mixer. The method may further include processing, via a controller of the stand mixer appliance, the feedback measurements. The method may further include determining, via the controller, one or more operating parameters based at least in part on the feedback measurements. The method may further include operating, via the controller, a motor drive of the stand mixer appliance based at least in part on the one or more operating parameters.

Another example aspect of the present disclosure is directed to a stand mixer appliance. The stand mixer appliance may include a base, a housing pivotally mounted to the base, a mixer shaft rotatably mounted on the housing, and a motor assembly. The motor assembly may include a motor having at least a rotor and a stator. The motor may be operably coupled to the mixer shaft such that the mixer shaft is rotatable by the motor. The motor assembly may further include a motor drive and a sensorless feedback system having one or more feedback circuits coupled to the motor drive. The sensorless feedback system may be configured to obtain feedback measurements of one or more electrical characteristics of the stator. Th motor assembly may further include a controller operably coupled to the sensorless feedback system and is configured to implement a six-step commutation control scheme. The controller may be configured to operate the motor drive based at least in part on the feedback measurements obtained by the sensorless feedback system.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a side-section view of a stand mixer according to example embodiments of the present disclosure;

FIG. 2 depicts a perspective view of a motor housing of the example stand mixer of FIG. 1 according to example embodiments of the present disclosure;

FIG. 3 depicts a perspective view of a motor in the motor housing of FIG. 2 according to example embodiments of the present disclosure;

FIG. 4 depicts a schematic diagram of an example synchronous motor according to example embodiments of the present disclosure;

FIG. 5A depicts a schematic diagram of an example motor assembly according to example embodiments of the present disclosure;

FIG. 5B depicts a correlated plot of electrical characteristics of the example motor assembly of FIG. 5A in a six-step commutation control scheme according to example embodiments of the present disclosure;

FIG. 6A depicts a schematic diagram of an example motor assembly operating in a first operating state according to example embodiments of the present disclosure;

FIG. 6B depicts a schematic diagram of the example motor assembly of FIG. 6A operating in a second operating state according to example embodiments of the present disclosure;

FIG. 7 depicts a schematic diagram of an example motor assembly according to example embodiments of the present disclosure; and

FIG. 8 depicts a flow diagram of an example method for operating a stand mixer appliance according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure relate generally to stand mixer appliances.

Stand mixers generally have a bowl and a head onto which attachments, such as mixing attachments, are mounted. The head may have an output carrier that spins in one direction about a central axis and an output shaft (i.e., mixer shaft) that rotates in another direction. In this regard, the output shaft is attached to the output carrier but is offset from the central axis. A motor spins the output shaft and the output carrier, which in turn spins the attachment and mixes material within the bowl.

A motor refers to a class of electro-mechanical devices that are capable of producing revolving motion in response to electrical signals. Motors typically include a stationary, and typically mounted, stator configured to encase or surround a rotor. The rotor and/or stator are electrically and/or magnetically charged to induce rotational motion between the rotor or stator. A variable speed motor refers to a class of motors in which the rotational speed of the rotor can be varied by modifying the timing at which the windings in the rotor and/or stator are charged. One of ordinary skill in the art will understand that various motors exist in the state of the art, and those variations are within the scope of the present disclosure, when appropriate.

Stand mixers are used in a variety of different applications to automate a variety of different tasks. For instance, stand mixers are used for, e.g., stirring, whisking, beating, and/or kneading. As such, stand mixers require a robust motor drive which is capable of both low speed, high torque operation and high speed, low torque operation. At present, stand mixers typically include a motor drive that uses a brushed direct current (DC) motor. Brushed DC motors utilize “brushes” to produce commutation. Over time, however, these “brushes” break down due to various factors (e.g., friction, heat), thereby decreasing motor life and increasing maintenance costs.

According to example aspects of the present disclosure, a stand mixer may include a motor assembly having a synchronous-type motor and a three-phase motor drive operating in a commutation control scheme (e.g., six-step commutation control scheme). Synchronous-type motors operating with such a control scheme provide high efficiency and high-fidelity speed and/or position control.

As will be discussed in greater detail below, synchronous-type motors, such as a BLDC motor, include three motor phase windings (e.g., stator windings). In a traditional six-step commutation scheme of synchronous-type motors, voltage is applied across two of the three motor phase windings. As such, a series direct-current (DC) current flows through the two windings, while the third winding is left floating. Put differently, while the voltage is being applied across the two active windings, a high-side transistor and a low-side transistor associated with the floating winding are off.

The two phases which are being driven at a given time (e.g., the active windings) are determined based at least in part on the orientation of the rotor magnetic field (Br). A direction of current flow that is induced by the voltage applied to the two active windings is also determined based at least in part on the orientation of the rotor magnetic field (Br). Hence, accurate knowledge of the flux angle or rotor magnetic field (Br) of the rotor is necessary to determine an appropriate combination of three-phase currents that correctly orient a stator magnetic field (Bs). Additionally, a speed signal may be useful for speed control. It is possible to acquire this information directly with some type of sensor (e.g., encoder, x3 Hall effect sensor, displacement sensor, etc.) that is mounted to the motor. However, sensored approaches are often more costly and less reliable than a sensorless approach due to the need for additional hardware and parts. As such, a stand mixer appliance operating in a sensorless commutation control scheme is desirable.

Accordingly, example aspects of the present disclosure provide a stand mixer appliance having a synchronous-type motor with a three-phase motor drive operating in a sensorless (e.g., six-step) commutation scheme. More particularly, the stand mixer may include a brushless DC (BLDC) motor or a permanent magnet synchronous motor (PMSM) and a three-phase motor drive. Furthermore, the stand mixer may include a sensorless feedback system having one or more feedback circuits coupled to the motor drive that is configured to obtain feedback measurements of one or more electrical characteristics (e.g., voltage, current, etc.) from the motor. The stand mixer may further include a controller operably coupled to the sensorless feedback system that is configured to implement a six-step commutation control scheme. More particularly, the controller may be configured to operate the motor drive based at least in part on the feedback measurements obtained by the sensorless feedback system.

As noted above, some knowledge of the orientation of the rotor magnetic field (Br) is required in order to effectively and efficiently drive the motor. As will be discussed in greater detail below, the back electromotive force (BEMF) of the motor is related to the rotor magnetic field (Br) of motor. As such, example aspects of the present disclosure provide a sensorless commutation control scheme that makes use BEMF measurements obtained by the sensorless feedback system. More particularly, to get the maximum torque-per-amp out of the motor, the two active windings (e.g., the two windings conducting current) should match the phase-phase BEMF which is peaking at that time. As such, example aspects of the present disclosure provide systems and methods that take advantage of the floating winding by measuring the BEMF (via the sensorless feedback system) of the floating winding, because BEMF voltage is still present in the floating winding when the current is zero.

By way of example, the motor may include three phase windings-phase A, phase B, and phase C. To induce a current across phase A and phase B, a low-side transistor associated with a phase B switching leg is turned on, and a high-side transistor associated with a phase A switching leg is pulsed (e.g., pulse width modulated (PWM)). It should be noted that, in this example, phase C is the floating phase. During this time, all other high-side and low-side transistors, including those associated with phase C, are off. When the high-side transistor associated with phase A is off (e.g., in-between pulses), the inductance of the motor windings maintains the flow of current through the motor. In other words, to complete the conduction path, an anti-parallel diode of the low-side transistor associated with phase A is forced to conduct.

In this state, a voltage between the phase C terminal and a ground of the motor drive will be equal to approximately 150% (i.e., 1.5 times greater than) of the BEMF of phase C during the time the high-side transistor associated with phase A is off (e.g., in-between pulses). Thus, by coupling a feedback circuit to the phase C switching leg output, the feedback circuit may obtain feedback measurements of the BEMF of phase C. The controller may then determine one or more operating parameters based at least in part on the feedback measurements obtained by the feedback circuit. For instance, based at least in part on the feedback measurements of the BEMF of phase C, the controller may determine an orientation of the rotor. The controller may also determine the commutation timing (for use in the six-step commutation control scheme) based at least in part on the feedback measurements of the BEMF of phase C. It should be understood that, in order to measure the BEMF in all commutation steps, the sensorless control system may further include additional feedback circuits coupled to the phase A switching leg output and the phase B switching leg output, respectively.

Additionally, in some implementations, the sensorless feedback system may further include a resistor network (e.g., a balanced wye resistor network) between the switching legs, such as the phase A switching leg, the phase B switching leg, and the phase C switching leg. In this manner, a virtual neutral point may be created. It should be understood that, when the motor is a balanced wye connected motor, the voltage at the virtual neutral is approximately equivalent to the actual neutral voltage of the motor. When the motor windings are in a delta configuration, it should be understood that the voltage at the virtual neutral is approximately equivalent to the neutral voltage of an equivalent wye connected motor. In such implementations, the one or more feedback circuits may obtain feedback measurements of the voltage from the inactive switching leg (e.g., associated with the floating winding) to determine a phase-neutral BEMF of the floating winding. The controller may then determine the one or more operating parameters based at least in part on the feedback measurements of the phase-neutral BEMF of the floating phase in a similar manner as discussed above.

The systems and methods according to example embodiments of the present disclosure provide a number of technical effects and benefits. For instance, example aspects of the present disclosure provide a highly reliable and efficient motor drive for use in a stand mixer operating in a six-step commutation control scheme. Moreover, by implementing a sensorless feedback system, example aspects of the present disclosure allow for more reliable and cheaper control systems. More particularly, by providing a sensorless feedback system having one or more feedback circuits coupled to the switching leg outputs of the motor drive, the one or more feedback circuits may be incorporated into the motor drive hardware, thereby preventing the need for additional harnessing. The sensorless feedback system also eliminates the need for damage-prone sensors on the motor that also require additional harnessing. Even further, in implementations where the sensorless feedback system includes a resistor network, example aspects of the present disclosure provide for more flexibility with sampling times, because the resistor network allows for continuous and more robust feedback sampling.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

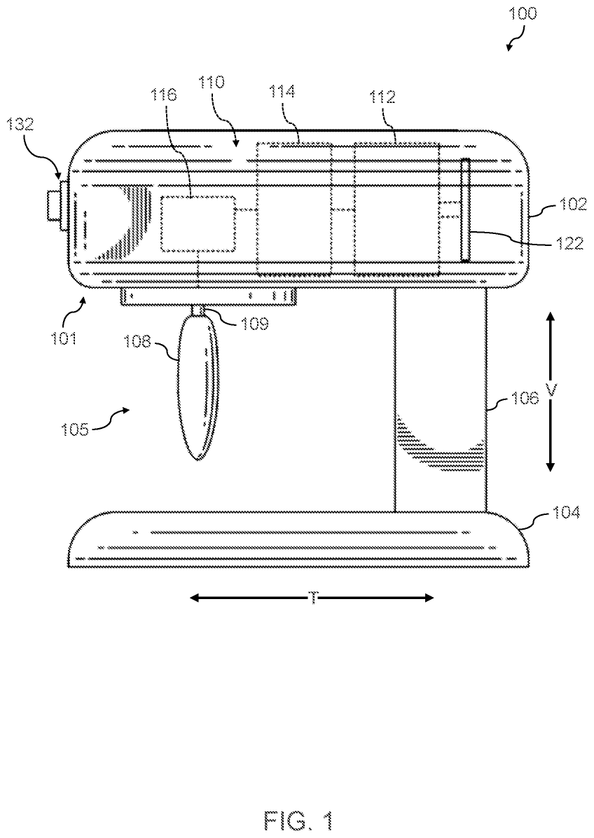

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

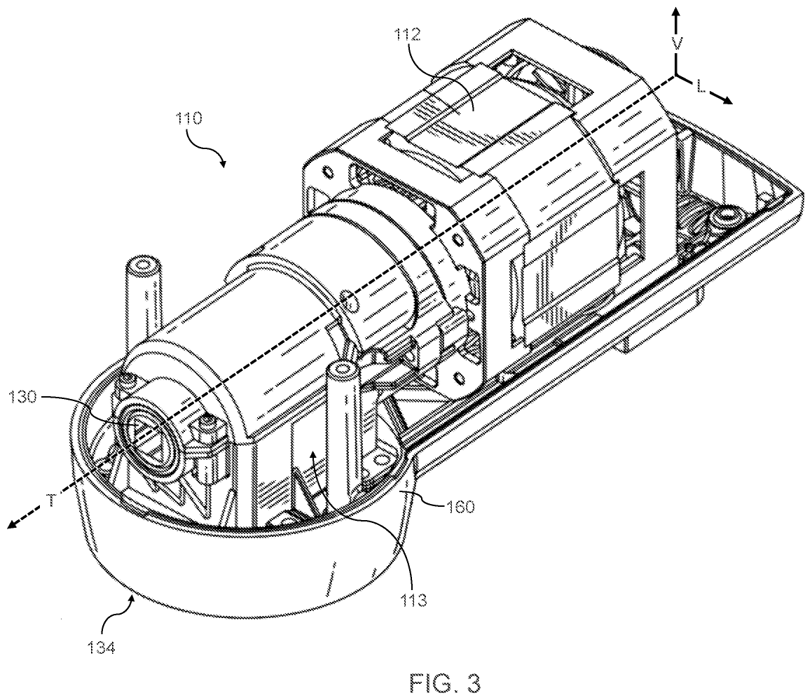

A drivetrain 110 may be provided within motor housing 102 and is configured for coupling motor 112 to a shaft 109 (e.g., a mixer shaft), such that shaft 109 is rotatable via motor 112 through drivetrain 110. In this way, the motor 112 can be operably coupled to the mixer shaft 109. Drivetrain 110 may include planetary gearbox 114, bevel gearbox 116, etc. An opening 132 for a horizontal output shaft 130 (FIG. 3) may align with the rotational axis of motor 112. Mixer shaft 109 may be positioned above mixing zone 105 on motor housing 102 (e.g., rotatably mounted on the housing 102), and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments, such as, e.g., a brushless DC (BLDC) motor. In alternative example embodiments, motor 112 may be an alternating current (AC) motor, such as, e.g., a permanent magnet synchronous motor (PMSM). Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

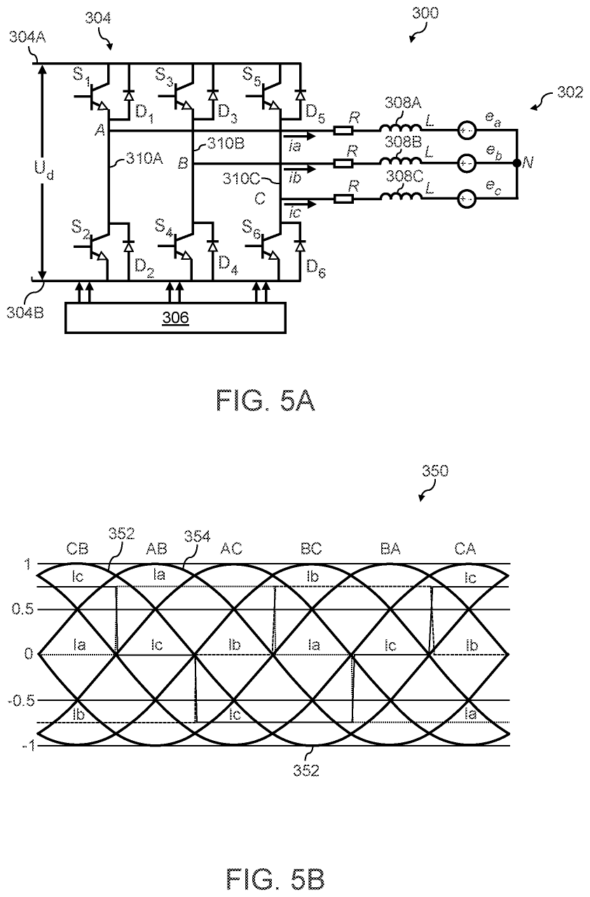

Stand mixer 100 may include a controller 122 provided within casing 101. For example, controller 122 may be located within motor housing 102 of casing 101. Controller 122 may be a microcontroller, as would be understood, including one or more processing devices, memory devices, or controllers. Controller 122 may include a plurality of electrical components configured to permit operation of stand mixer 100 and various components therein (e.g., motor 112). For instance, controller 122 may be on a printed circuit board (PCB), as would be well known. Furthermore, as will be discussed in greater detail with respect to FIGS. 5A-5B, the controller 122 may be configured to implement a control scheme such as, e.g., a six-step control scheme. One of ordinary skill in the art will understand that, despite focusing the description herein to six-step control schemes, alternative control schemes (e.g., field-oriented control (FOC), direct torque control, etc.) can be implemented without deviating from the scope of the present disclosure.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 122 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 122 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

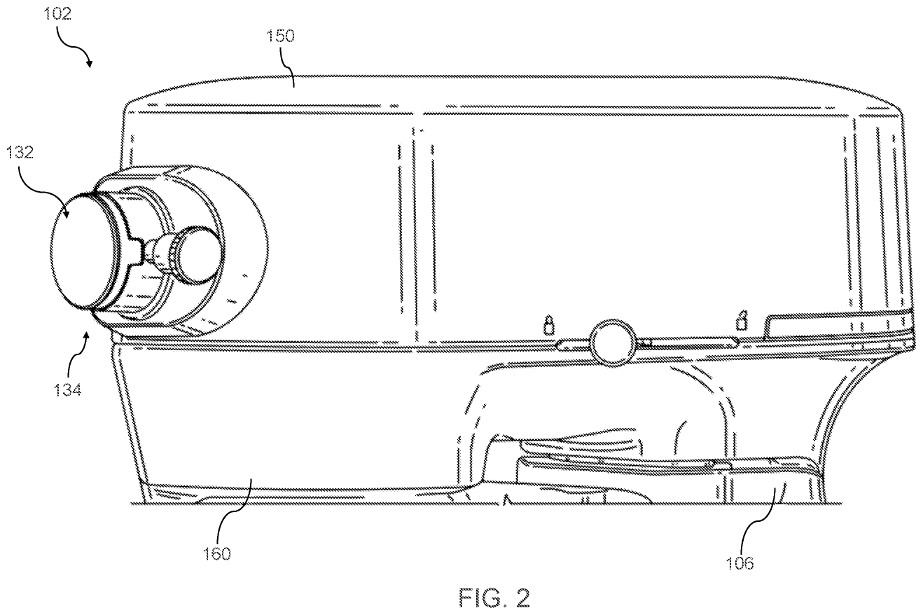

FIG. 2 illustrates a perspective view of motor housing 102. As shown, motor housing 102 may include a first portion 150 and a second portion 160. Thus, e.g., motor housing 102 may include a two-piece structure that collectively forms motor housing 102. Moreover, first portion 150 may couple to second portion 160 to form motor housing 102. Second portion 160 may be mounted, e.g., pivotally, to column 106. As stated above, an opening 132 for a horizontal output shaft 130 (FIG. 3) may be defined by motor housing 102. Opening 132 may be positioned on a front portion 134 of motor housing 102 for easy access for an operator.

FIG. 3 illustrates the second portion 160 of motor housing 102 with motor 112 and a motor assembly 113 shown. Motor assembly 113 may include components of drivetrain 110, e.g., planetary gearbox 114, bevel gearbox 116, and horizontal output shaft 130. Motor assembly 113 may be mounted within second portion 160 such that the axis of rotation of the motor is axially aligned with the transverse direction T. Additionally, motor assembly 113 may be mounted within second portion 160 such that horizontal output shaft 130 is positioned proximate front portion 134.

For instance, synchronous-type motors (e.g., motor 112) may be driven by a six-step commutation control scheme, which provides for efficient and high-fidelity control. In six-step commutation control schemes, a stator magnetic field is generated by a stator current, which is provided through one or more stator windings at the stator. The stator field is oriented at a fixed angular offset ahead of a rotor magnetic field at the rotor. For instance, the rotor field may be produced by one or more permanent magnets or other permanent magnetic poles at the rotor. The angular offset between the rotor field and the stator field induces rotational motion at the rotor as the rotor field tries to align itself with the stator field. By continually moving the stator field (e.g., per phases of the stator current), the rotor is made to synchronously rotate with the stator field.

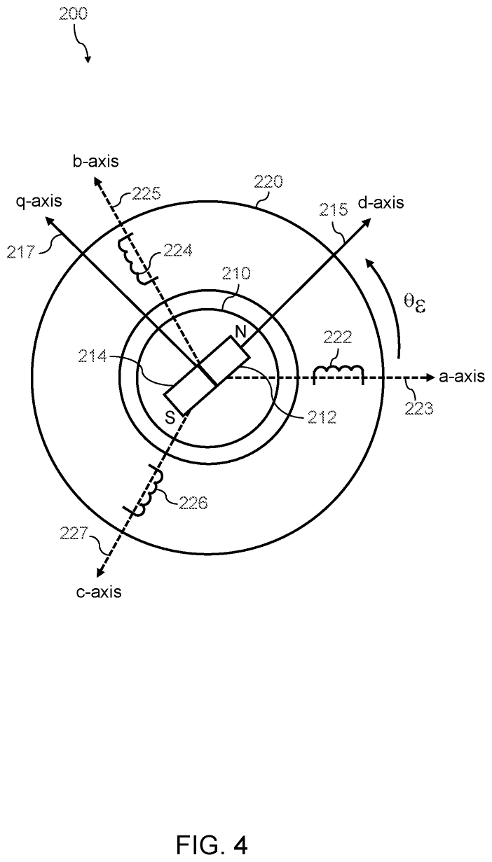

FIG. 4 depicts a schematic diagram of an example synchronous-type motor 200 according to example embodiments of the present disclosure. As illustrated, motor 200 includes rotor 210 and stator 220. Rotor 210 includes a north magnetic pole 212 and south magnetic pole 214. It should be understood that rotor 210 is discussed with reference to a single north magnetic pole 212 and a single south magnetic pole 214 for the purposes of illustration. Rotor 210 can include any suitable (e.g., balanced) number of north and south magnetic poles. The angle of the rotor magnetic field, represented by θₑ, is related to a mechanical angle of the rotor, represented by θₘ, by a number of rotor poles P. In particular, the angles are related by the equation:

$${θ}_{e} = \frac{P}{2} {θ}_{m} .$$

In addition, the (mechanical) rotor speed, represented by

$${ω}_{m} = \frac{d {θ}_{m}}{dt} ,$$

can be related to the electrical rotor speed, represented by

$${ω}_{e} = \frac{d {θ}_{e}}{dt} ,$$

by the equation:

$${ω}_{e} = \frac{P}{2} {ω}_{m} .$$

In operating the motor 200, three-phase power (e.g., current/voltage signals) can be provided at each of the stator windings 222, 224, and 226. For instance, stator winding 222 can be positioned along a-axis 223. Stator winding 224 can be positioned along b-axis 225 and can receive a power signal that is 120 degrees out of phase with the signal of stator winding 222. Additionally, stator winding 226 can be positioned along c-axis 227 and can receive a power signal that is-120 degrees or 240 degrees out of phase with stator winding 222.

A convenient way to represent the behavior of the motor 200 is to treat the three-phase voltages and currents as rotating space vectors. The rotating space vectors can be broken up into cartesian components. A first component, termed the direct component or D component, can be in phase with the rotor magnetic field. This component is directed along the d-axis 215. A second component, termed the quadrature component or Q component, can be out of phase with the direct component, such as 90 degrees out of phase with the direct component. For instance, this component can be directed along the q-axis 217.

In particular, voltages and currents in the rotating-space dq reference frame can be translated from the three-phase abc reference frame by suitable transforms. For instance, one example set of transforms, the Park Transform and Clarke Transform, can be performed in cascade to convert between rotating-space and three-phase. In particular, an example Park Transform is given by:

$$[ \begin{matrix}d \\ q\end{matrix} ] = [ \begin{matrix}cos {θ}_{e} & sin {θ}_{e} \\ - sin {θ}_{e} & cos {θ}_{e}\end{matrix} ] [ \begin{matrix}α \\ β\end{matrix} ]$$

and an example Clarke Transform is given by:

$$[ \begin{matrix}α \\ β\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}}\end{matrix} ] [ \begin{matrix}a \\ b \\ c\end{matrix} ]$$

Note that alternate versions of the above transformations exist, accounting for variations in the location of a zero reference angle, whether the transformation preserves amplitude or power, etc.

In the dq frame, the electrical dynamics of the stator windings can be given by:

$$[ \begin{matrix}{v}_{d} \\ {v}_{q}\end{matrix} ] = [ \begin{matrix}{R}_{s} & - {ω}_{e} {L}_{q} \\ {ω}_{e} {L}_{d} & {R}_{s}\end{matrix} ] [ \begin{matrix}{I}_{d} \\ {I}_{q}\end{matrix} ] + [ \begin{matrix}{L}_{d} & 0 \\ 0 & {L}_{q}\end{matrix} ] [ \begin{matrix}{\dot{I}}_{d} \\ {\dot{I}}_{q}\end{matrix} ] + {λ}_{m} {ω}_{e} [ \begin{matrix}0 \\ 1\end{matrix} ]$$

where Rₛ is the resistance of the stator windings; L_{d}, L_{q} are the d and q axis inductances of the stator windings, which may differ from each other based on the rotor construction; and λₘ is the magnitude of the rotor magnetic flux linkage, which can be constant for a sinusoidal motor. The voltage term λₘ ωₑ is known as the back electromotive force (EMF) (or counter-electromotive force), and, as can be seen in the above equation, has magnitude proportional to the rotor electrical speed ωₑ. Because the magnitude of the back EMF is proportional to rotor speed, it is difficult to accurately estimate at low rotor speeds. Because of this, many existing observer algorithms may fail to accurately track the back EMF term at low speeds.

FIG. 5A depicts a schematic diagram of an example motor assembly 300 according to example embodiments of the present disclosure. It should be noted that the motor assembly 300 may used in a stand mixer appliance, such as stand mixer 100 (FIGS. 1-3). As will be discussed in greater detail below, the motor assembly 300 may operate in a six-step commutation control scheme. More particularly, as shown, the motor assembly 300 may include motor 302 such as, e.g., a permanent magnet synchronous motor (PMSM) or a brushless DC (BLDC) motor. The motor 302 may be driven by a reversible three-phase motor drive, which can include the three-phase inverter 304 coupled to an alternating current (AC) power supply (not shown). The motor drive (e.g., inverter 304 and the power supply) may be operably coupled to a controller 306 that is configured to implement the six-step commutation control scheme. Furthermore, as will be discussed in greater detail below, the controller 306 may be operably coupled to a sensorless feedback system and may be configured to operate the motor drive (e.g., inverter 304) based at least in part on feedback measurements obtained by the sensorless feedback system.

The inverter 304 may likewise be operably coupled to the power supply and configured to control motor 302. For instance, inverter 304 may supply current signals to one or more motor phase windings (e.g., stator windings 308A-308C) at motor 302 such that the motor 302 produces rotational motion. As one example, the inverter 304 may supply three-phase current signals iₐ, i_{b}, and i_{c} to stator windings 308A, 308B, 308C (respectively) at the motor 302 in synchronous timing such that a (e.g., permanent magnet) rotor at motor 302 rotates. The inverter 304 may produce the current signals in response to a control signal from the controller 306. The controller 306 may be configured to control the inverter 304 and provide a current to one or more stators of the motor 302 to induce a stator magnetic field. In this way, the controller 306 may control an orientation of the stator magnetic field.

The inverter 304 may include a plurality of switching devices to regulate current flow from the inverter 304 to the motor 302, such as transistors S1-S6. More particularly, the inverter 304 may include a plurality of high-side transistors S1, S3, S5 (coupled to a positive voltage rail 304A) and a plurality of low-side transistors S2, S4, S6 (coupled to ground/negative rail 304B). Furthermore, each of the stator windings 308A, 308B, 308C may be associated with at least two switching devices (e.g., at least one high-side transistor and at least one low-side transistor) that together form a switching leg. For instance, stator winding 308A may be coupled to high-side transistor S1 and low-side transistor S2 (i.e., switching leg 310A), stator winding 308B may be coupled to high-side transistor S3 and low-side transistor S4 (i.e., switching leg 310B), and stator winding 308C may be coupled to high-side transistor S5 and low-side transistor S6 (i.e., switching leg 310C). Those having ordinary skill in the art will understand that a “switching leg” refers to a pair of switching devices that are used to control the flow of current through the respective stator winding.

The controller 306 may control the direction of current flow through the stator windings 308A-308C by alternately turning the transistors S1-S6 on and off in a specific sequence (hereinafter “commutation sequence”). As noted above, in a traditional six-step commutation sequence, voltage is applied across two of the three stator windings 308A-308C such that a series DC current flows through the two energized windings, while the other winding is left open and not conducting (i.e., “floating”).

To get the maximum torque-per-amp out of motor 302, the phases conducting current (i.e., the two energized windings) should match the phase-phase back electromotive force (BEMF) that is peaking at that time. By way of example, referring now to FIG. 5B, an example six step commutation sequence 350 is depicted. As shown, the commutation sequence 350 includes six steps, each of which being defined by the two phases conducting current and the direction of the induced current. More particularly, the commutation sequence 350 includes step CB (where stator windings 308C, 308B are conducting and stator winding 308A is floating), step AB (where stator windings 308A, 308B are conducting and stator winding 308C is floating), and step AC (where stator windings 308A, 308C are conducting and stator winding 308B is floating). The commutation sequence 350 also includes step BC (corresponding to step CB with the reverse polarity), step BA (corresponding to step AB with the reverse polarity), and step CA (corresponding to step AC with the reverse polarity).

As noted above, to maximize the torque-per-amp out of motor 302, the conducting phases (e.g., stator windings 308A-308C) should match the phase-phase BEMF that is peaking at that time. As an illustrative example, step CB will be discussed in more detail.

Line 352 represents the BEMF of phase C (i.e., stator winding 308C) with respect to phase B (i.e., stator winding 308B). As shown, when the BEMF of phase C with respect to phase B (represented by line 352) is peaking, a positive current is induced in stator winding 308C (I_{C}) and a negative current is induced in stator winding 308B (Ip). This is accomplished by turning on the low-side transistor S4 associated with stator winding 308B while pulsing (e.g., PWM) the high-side transistor S5 associated with stator winding 308C. All of the other transistors, including both the high-side transistor S1 and low-side transistor S2 associated with stator winding 308A, are turned off. Hence, in phase CB, stator winding 308A is left floating. Although not discussed, those having ordinary skill in the art, using the disclosures provided herein, will understand that the same principles likewise apply to the steps AB, AC, BC, BA, and CA.

After the BEMF of phase C with respect to phase B (represented by line 352) peaks, however, it then begins to decrease. Thus, in order to maintain maximum torque-per-amp of the motor 302, the commutation sequence 350 must switch to a different step. For instance, as the BEMF of phase C with respect to phase B (represented by line 352) begins to decrease, the BEMF of phase A with respect to phase B (represented by line 354) is beginning to peak. As such, following step CB, the commutation must switch to step AB in order to maintain the maximum torque-per-amp (and rotation) of the motor 302.

The timing of the switch between steps in commutation sequence 350 is crucial to the efficiency and effectiveness of the motor 302; the proper commutation timing depends in large part on a position of the rotor of the motor 302 and/or the orientation of the rotor magnetic rotor magnetic field (Br) of motor 302. As noted above, in sensored approaches, this information may be obtained directly with a sensor (e.g., encoder, x3 Hall effect sensor, displacement sensor, etc.) that is mounted to the motor 302. However, as noted above, sensored approached are more costly and less reliable than a sensorless approach due to the need for additional hardware and parts (as ωell as the maintenance thereof). Accordingly, example aspects of the present disclosure provide a sensorless six-step commutation control scheme based at least in part on feedback measurements indicative of the BEMF of a floating phase winding of the motor 302, thereby providing for effective and efficient control of the motor 302.

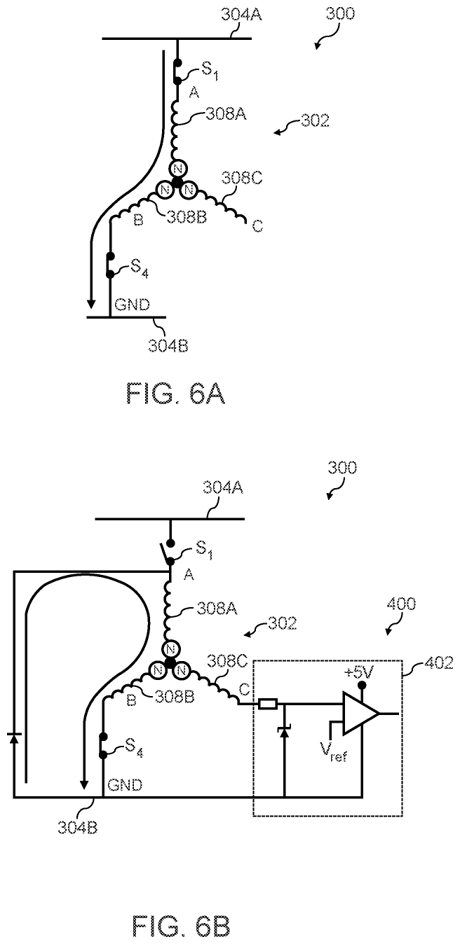

FIG. 6A depicts a schematic diagram of the example motor assembly 300 operating in a first operating state according to example embodiments of the present disclosure, and FIG. 6B depicts a schematic diagram of the example motor assembly 300 operating in a second operating state according to example embodiments of the present disclosure. It should be noted that FIGS. 6A-6B depict step AB in commutation sequence 350 (FIG. 5B). Furthermore, the first operating state depicted in FIG. 6A corresponds to an operating state in step AB where the high-side transistor S1 associated with stator winding 308A is being pulsed (i.e., PWM “ON” state), and the second operating state depicted in FIG. 6B corresponds to an operating state in step AB in-between pulses to high-side transistor S1 (i.e., PWM “OFF” state).

As shown in FIG. 6A, current is being induced across stator winding 308A (i.e., phase A) and stator winding 308B (i.e., phase B), while stator winding 308C (i.e., phase C) is left open and not conducting (i.e., “floating”). More particularly, the low-side transistor S4 associated with stator winding 308B is turned on, and the high-side transistor S1 associated with stator winding 308A is pulsed (hence, PWM “ON” state), thereby inducing a current across the stator windings 308A, 308B. Conversely, FIG. 6B depicts the conduction path in the motor assembly 300 in between the pulses to the high-side transistor S1 associated with stator winding 308A (hence, PWM “OFF” state).

As shown in FIG. 6B, in order to implement a sensorless six-step commutation control scheme, the motor assembly 300 may include a sensorless feedback system 400 configured to obtain feedback measurements of one or more electrical characteristics of the motor 302. More particularly, the sensorless feedback system 400 may be coupled to the switching leg 310C of stator winding 308C, which, as noted above, is the floating phase in step AB. It should be noted that only one sensorless feedback system 400 is depicted in FIG. 6B for purposes of illustration and discussion. Those having ordinary skill in the art, using the disclosures provided herein, will understand that a motor assembly according to the present disclosure may include a sensorless feedback system coupled to each switching leg of each stator winding.

As shown, the sensorless feedback system 400 may include one or more feedback circuits, such as feedback circuit 402. In this manner, the sensorless feedback system 400 (via feedback circuit 402) is operable to obtain feedback measurements of one or more electrical characteristics (e.g., BEMF) of the stator winding 308C which, as noted above, is the floating phase in step AB. Subsequently, the controller 306 (FIG. 4A) may process the feedback measurements obtained by the sensorless feedback system 400 and, based at least in part on the feedback measurements, determine one or more operating parameters of the motor assembly 300.

More particularly, the sensorless feedback system 400 may obtain feedback measurements of the voltage between the stator winding 308C and the ground of the inverter 304 (e.g., rail 304B) in between the pulses to the high-side transistor S1 associated with the stator winding 308A. Given the relationship between the phase C voltage and the BEMF of phase C (during the PWM “OFF” state), the BEMF of the stator winding 308C may be determined. The controller 306 may then determine a zero-crossing of the BEMF of stator winding 308C; based at least in part on the zero-crossing, the controller 306 may also determine a phase of the BEMF of the stator winding 308C. Furthermore, based at least in part on the feedback measurements, the controller 306 may then determine one or more operating parameters of the motor 302, such as an orientation of the rotor and the proper commutation timing of the commutation sequence 350 (FIG. 5B). In this manner, the controller 306 may control the motor drive (e.g., inverter 304) to provide a current to the stator windings 308A-308C based at least in part on the commutation timing, thereby controlling an orientation of the stator magnetic field (Bs).

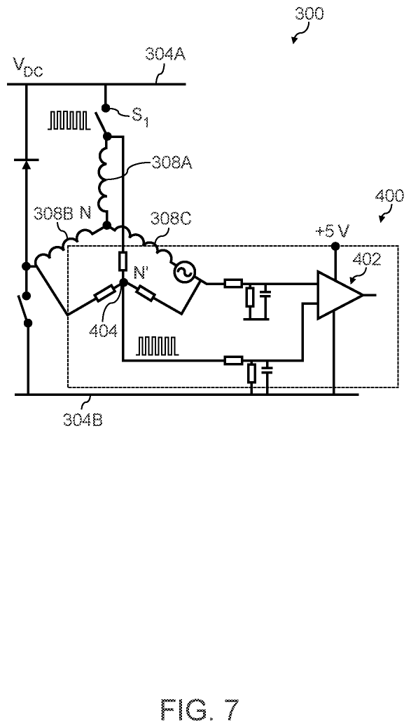

FIG. 7 depicts a schematic diagram of an example motor assembly 300 according to example embodiments of the present disclosure. In some implementations, such as that depicted in FIG. 7, the sensorless control system 400 may further include a resistor network 404 (e.g., a balanced wye resistor network) between the switching legs 310A-310B. As such, a virtual neutral point N′-which has a voltage approximately equivalent to the voltage at the neutral point N of the motor 302—may be created in the motor assembly 300, which allows the sensorless feedback system 400 to obtain feedback measurements of the BEMF between the floating phase (e.g., stator winding 308C) and the virtual neutral point N′ (e.g., phase-neutral BEMF) at any time (i.e., in both the PWM “ON” state and the PWM “OFF” state). In this manner, the sensorless feedback system 400 depicted in FIG. 7 provides more flexibility in the sampling time of the BEMF of the floating phase winding.

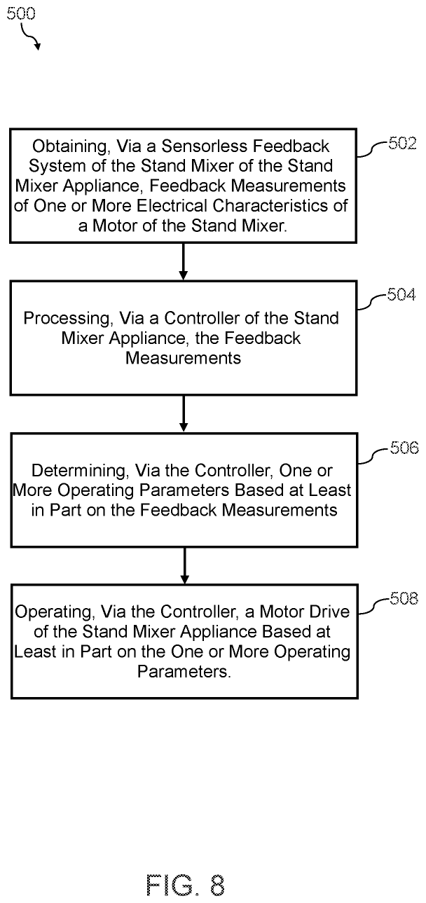

FIG. 8 depicts an example method 500 for operating a stand mixer appliance according to example embodiments of the present disclosure. More particularly, the method 500 may be implemented in a six-step commutation control scheme for a stand mixer appliance. FIG. 8 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 500 is generally discussed with reference to the stand mixer 100 described above with reference to FIGS. 1-3, the motor 200 described above with reference to FIG. 4, and the motor assembly 300 and commutation sequence 350 described above with reference to FIGS. 4A-7. However, it should be understood that aspects of the present method 500 can find application with any suitable appliance, motor assembly, motor, and/or commutation sequence.

At (502), the method 500 may include obtaining, via a sensorless feedback system of the stand mixer of the stand mixer appliance, feedback measurements of one or more electrical characteristics of a motor of the stand mixer. More particularly, the sensorless feedback system 400 of the stand mixer appliance 100 may obtain feedback measurements of a back electromotive force (BEMF) of a floating phase winding (e.g., stator windings 308A-308C) of the motor 302 and may provide data indicative of the floating phase BEMF to the controller 306.

At (504), the method 500 may include processing, via a controller of the stand mixer appliance, the feedback measurements. More particularly, the controller 306 may obtain the feedback measurements of the floating phase BEMF from the sensorless feedback system 400 and may process the feedback measurements. For instance, the controller 306 may determine a zero-crossing of the floating phase BEMF based at least in part on the feedback measurements. The controller 306 may also determine a phase of the floating phase BEMF based at least in part on the zero-crossing of the floating phase BEMF.

At (506), the method 500 may include determining, via the controller, one or more operating parameters based at least in part on the feedback measurements. More particularly, the controller 306 may determine the rotor orientation of the motor 302 based at least in part on the phase of the floating phase BEMF. The controller 306 may also determine the commutation timing for the six-step commutation sequence 350 based at least in part on the phase of the floating phase BEMF.

At (508), the method 500 may include operating, via the controller, a motor drive of the stand mixer appliance based at least in part on the one or more operating parameters. More particularly, the controller 306 may control the inverter 304 to provide a current (e.g., I_{A}, I_{B}, I_{C}) to a stator winding 308A-308C based at least in part on the commutation timing to induce a stator magnetic field (\vec{B}ₛ). In this manner, the controller 306 may control an orientation of the stator magnetic field (\vec{B}ₛ).

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A motor assembly for a stand mixer, comprising:
a motor comprising at least a rotor and a stator;
a motor drive;
a sensorless feedback system comprising one or more feedback circuits coupled to the motor drive, the sensorless feedback system configured to obtain feedback measurements of one or more electrical characteristics of the stator; and
a controller operably coupled to the sensorless feedback system, the controller configured to operate the motor drive based at least in part on the feedback measurements obtained by the sensorless feedback system.

2. The motor assembly of claim 1, wherein the motor drive is a reversible three-phase motor drive comprising a three-phase inverter coupled to an alternating current (AC) power supply.

3. The motor assembly of claim 1, wherein the motor is a brushless direct current (BLDC) motor.

4. The motor assembly of claim 1, wherein the controller is configured to implement a six-step commutation control scheme.

5. The motor assembly of claim 4, wherein:
the motor comprises a first stator winding, a second stator winding, and a third stator winding; and
the sensorless feedback system comprises a first feedback circuit coupled to a switching leg of the first stator winding, a second feedback circuit coupled to a switching leg of the second stator winding, and a third feedback circuit coupled to a switching leg of the third stator winding.

6. The motor assembly of claim 4, wherein the controller is configured to:
process the feedback measurements obtained by the sensorless feedback system;
determine one or more operating parameters based at least in part on the feedback measurements; and
operate the motor drive based at least in part on the one or more operating parameters.

7. The motor assembly of claim 6, wherein the sensorless feedback system is configured to obtain feedback measurements of a back electromotive force (BEMF) of a floating phase of the motor.

8. The motor assembly of claim 7, wherein the controller is configured to:
determine a zero-crossing of the BEMF of the floating phase of the motor based at least in part on the feedback measurements; and
determine a phase of the BEMF of the floating phase of the motor based at least in part on the zero-crossing of the BEMF.

9. The motor assembly of claim 7, wherein the controller is configured to determine a commutation timing for the six-step commutation control scheme based at least in part on the BEMF of the floating phase of the motor.

10. The motor assembly of claim 9, wherein the controller is configured to:
control the motor drive to provide a current to the stator based at least in part on the commutation timing to induce a stator magnetic field; and
control an orientation of the stator magnetic field.

11. The motor assembly of claim 6, wherein the one or more operating parameters are indicative of an orientation of the rotor.

12. The motor assembly of claim 1, wherein:
the stator comprises one or more stator windings;
the motor drive comprises one or more switching legs coupled to the one or more stator windings; and
the sensorless feedback system further comprises a resistor network between the one or more switching legs.

13. The motor assembly of claim 12, wherein the resistor network is a balanced wye resistor network.

14. A method for operating a stand mixer appliance, the method comprising:
obtaining, via a sensorless feedback system of the stand mixer of the stand mixer appliance, feedback measurements of one or more electrical characteristics of a motor of the stand mixer;
processing, via a controller of the stand mixer appliance, the feedback measurements;
determining, via the controller, one or more operating parameters based at least in part on the feedback measurements; and
operating, via the controller, a motor drive of the stand mixer appliance based at least in part on the one or more operating parameters.

15. The method of claim 14, wherein obtaining the feedback measurements comprises:
obtaining, via the sensorless feedback system, feedback measurements of a back electromotive force (BEMF) of a floating phase of the motor; and
providing, via the sensorless feedback system, data indicative of the BEMF of the floating phase of the motor to the controller.

16. The method of claim 15, wherein processing the feedback measurements comprises:
determining, via the controller, a zero-crossing of the BEMF of the floating phase of the motor based at least in part on the feedback measurements; and
determining, via the controller, a phase of the BEMF of the floating phase of the motor based at least in part on the zero-crossing of the BEMF.

17. The method of claim 16, wherein determining the one or more operating parameters comprises:
determining, via the controller, an orientation of a rotor of the motor based at least in part on the BEMF of the floating phase of the motor; and
determining, via the controller, a commutation timing for a six-step commutation control scheme implemented by the controller based at least in part on the BEMF of the floating phase of the motor.

18. The method of claim 17, wherein operating the motor drive of the stand mixer appliance comprises:
controlling, via the controller, the motor drive to provide a current to a stator of the motor based at least in part on the commutation timing to induce a stator magnetic field; and
controlling, via the controller, an orientation of the stator magnetic field.

19. A stand mixer appliance, comprising:
a base;
a housing pivotally mounted to the base;
a mixer shaft rotatably mounted on the housing; and
a motor assembly, the motor assembly comprising:
a motor comprising at least a rotor and a stator, the motor operably coupled to the mixer shaft such that the mixer shaft is rotatable by the motor;
a motor drive;
a sensorless feedback system comprising one or more feedback circuits coupled to the motor drive, the sensorless feedback system configured to obtain feedback measurements of one or more electrical characteristics of the stator; and
a controller operably coupled to the sensorless feedback system and configured to implement a six-step commutation control scheme, the controller configured to operate the motor drive based at least in part on the feedback measurements obtained by the sensorless feedback system.

20. The stand mixer appliance of claim 19, wherein the motor is a brushless direct current (BLDC) motor.
